(19) United States
(12) Patent Application Publication
(10) Pub. No.: US 2026/0087364 A1
(43) Pub. Date: Mar. 26, 2026

(54) NOISE-BASED HALLUCINATION DETECTION IN GENERATIVE ARTIFICIAL INTELLIGENCE MODELS

(71) Applicant: QUALCOMM Incorporated, San Diego, CA (US)

(72) Inventors: Litian LIU, San Diego, CA (US); Roland MEMISEVIC, Toronto (CA); Reza POURREZA, San Diego, CA (US); Sunny Praful Kumar PANCHAL, Toronto (CA); Apratim BHATTACHARYYA, San Diego, CA (US)

(21) Appl. No.: 18/975,920

(22) Filed: Dec. 10, 2024

Related U.S. Application Data
(60) Provisional application No. 63/699,424, filed on Sep. 26, 2024.

(51) Int. Cl. G06N 3/094; G06N 3/0475

(52) U.S. Cl. CPC G06N 3/094; G06N 3/0475

(57) ABSTRACT

Techniques and apparatus for generating content using a generative artificial intelligence model are described. An example method generally includes receiving an input prompt for processing using a generative artificial intelligence model. An output of a layer of the generative artificial intelligence model is generated based on the input prompt and noise injected into the layer of the generative artificial intelligence model. A response to the input prompt is generated based on the output of the layer of the generative artificial intelligence model. Based on a probability distribution associated with the response to the input prompt, a likelihood that the response is a hallucinatory output of the generative artificial intelligence model is determined, and the generated response is output based on the determined likelihood that the response is a hallucinatory output.

### CROSS-REFERENCE TO RELATED APPLICATIONS

This application claims priority to and benefit of U.S. Provisional Patent Application Ser. No. 63/699,424, entitled “Noise Enhanced Hallucination Detection in Generative Artificial Intelligence Models,” filed Sep. 26, 2024, and assigned to the assignee hereof, the entire contents of which are hereby incorporated by reference herein.

### INTRODUCTION

Aspects of the present disclosure relate to generative artificial intelligence models.

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include a latent diffusion model, in which a model generates an image or stream of images (e.g., video content) from an input text description of the content of the desired image or stream of images, decision transformers, in which future actions are predicted based on sequences of prior actions within a given environment, or the like.

While generative artificial intelligence models are capable of generating responses to a variety of input prompts, generative artificial intelligence models are also capable of generating erroneous or incorrect outputs. For example, large language models may “hallucinate” and generate outputs that are factually incorrect or include fabricated information that, in turn, can result in the inclusion of erroneous information in content generated using the outputs of large language models, cause autonomous systems to perform erroneous actions, and the like. These hallucinations can undermine the reliability and trustworthiness of large language models or other generative artificial intelligence models that are used to generate textual responses to an input prompt.

### BRIEF SUMMARY

Certain aspects of the present disclosure provide a method for generating content using a generative artificial intelligence model. An example method generally includes receiving an input prompt for processing using a generative artificial intelligence model. An output of a layer of the generative artificial intelligence model is generated based on the input prompt and noise injected into the layer of the generative artificial intelligence model. A response to the input prompt is generated based on the output of the layer of the generative artificial intelligence model. Based on a probability distribution associated with the response to the input prompt, a likelihood that the response is a hallucinatory output of the generative artificial intelligence model is determined, and the generated response is output based on the determined likelihood that the response is a hallucinatory output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example generative artificial intelligence model.

FIG. 2 illustrates an example generative artificial intelligence model in which noise is injected to determine whether the generative artificial intelligence model is hallucinating, according to certain aspects of the present disclosure.

FIG. 3 illustrates example operations for generating an output of a generative artificial intelligence model based on a likelihood that the generative artificial intelligence model is hallucinating, according to certain aspects of the present disclosure.

FIG. 4 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Certain aspects of the present disclosure provide apparatus, methods, processing systems, and computer-readable mediums for generating responses to input queries using a generative artificial intelligence model based on a determined likelihood of the responses being hallucinatory outputs of the generative artificial intelligence model.

Generally, a generative artificial intelligence model generates a response to a query input into the model. For example, a language model deployed within a chatbot can generate a response to a query using multiple passes through the language model, with each successive pass being based on the query and the tokens (or words) generated using previous passes through the language model. Generally, a response generated by a language model may be a sequence, or ordered set, of tokens (e.g., words or parts of words) generated from a sequence of input tokens representing an input query in such a manner that preserves the sequential relationships of words in the input query and captures dependencies between various tokens within the sequence of input tokens. An output of an inferencing round performed using a language model may be a probabilistic distribution or set of probability values over a universe of tokens that can be output in response to the input. For example, in a text-generation or completion task, a language model can select an output token as the token having the highest probability of completing or augmenting the text sequence, and the output and original input may subsequently be processed in another inferencing round using the language model until a terminating event is reached.

Hallucinations in generative artificial intelligence models, such as language models, occur when the model generates information that is factually incorrect or inconsistent with the input data or real-world knowledge. Hallucinations in language models arise from the probabilistic nature of such language models, as language models are generally trained to predict the most likely sequence of words based on patterns learned from vast datasets. During inferencing, the language model may interpolate or extrapolate information that appears coherent and contextually appropriate but is ultimately fabricated or inaccurate. These errors often occur when the language model encounters ambiguous, incomplete, or out-of-distribution data, leading the language model to rely on statistical correlations rather than factual correctness. Additionally, since language models do not inherently possess a grounded understanding of the real world, language models may generate outputs that sound plausible but are not verified against an external knowledge base.

Detecting hallucinations in generative artificial intelligence models may be accomplished using several techniques designed to identify instances where the model's output deviates from factual accuracy. One approach is cross-referencing the generated content with trusted external databases or knowledge graphs, which can serve as authoritative sources to verify the accuracy of specific claims. Another method involves employing consistency checks, where the model is prompted to re-generate outputs for the same input multiple times, with variations in responses being flagged as potential hallucinations. Post-processing techniques such as fact-checking algorithms or incorporating a secondary model trained to detect inconsistencies can help identify hallucinated information.

Token-level uncertainty methods address two types of uncertainty: epistemic, which arises from the inherent variability in data, and aleatoric, which stems from model uncertainty due to limited training data or model capacity. By leveraging combinations of language models and outputs thereof, token-level uncertainty can be quantified, allowing the model to assess the likelihood of hallucinations. Specifically, higher epistemic uncertainty has been shown to correlate more strongly with hallucinations than aleatoric uncertainty. Token-level uncertainty measurements allow for hallucination detection by calculating the entropy of token predictions; higher entropy indicates greater uncertainty and, consequently, a higher chance of generating hallucinations.

Lexical-level uncertainty involves calculating uncertainty based on n-gram models, which evaluate the probability of sequences of words (e.g., bigrams, trigrams) from a sample set. The n-gram model (which may work independently of a generative artificial intelligence model or be integrated into the generative artificial intelligence model) generates these n-grams from the training data, and the likelihood of each n-gram's occurrence is measured. When the n-gram model encounters rare or previously unseen word combinations, the uncertainty increases, signaling a potential hallucination. This technique may be effective in detecting hallucinations that arise from unusual or unnatural word sequences, often occurring in low-probability n-gram contexts.

Semantic-level uncertainty focuses on the relationships between groups of words or tokens that share similar meanings or are contextually linked. By analyzing the uncertainty over these semantic groupings, the generative artificial intelligence model can detect when the generative artificial intelligence model is uncertain about the relationships between different concepts. If the model struggles to assign clear meaning within these groups, the generative artificial intelligence model is more likely to generate semantically incoherent or hallucinated outputs. This approach may be used for detecting more complex forms of hallucination, where the overall structure of meaning is disrupted rather than individual tokens.

Embedding-level uncertainty measures the entropy of a matrix generated from the concatenation of word embeddings. Word embeddings are vector representations of words that capture their meanings based on their relationships to other words in a high-dimensional space. By calculating the entropy of this matrix, the generative artificial intelligence model assesses the dispersion and coherence of the embeddings. High entropy suggests a lack of clarity in the word relationships, indicating that the model is uncertain about the meaning of the generated text, which may result in hallucinations. Embedding-level uncertainty measurement techniques generally aid in identifying hallucinations where the model is unsure of the contextual meanings encoded in the embeddings.

Generally, the hallucination detection techniques discussed above are based on randomness derived from prediction layer sampling, with greater observed uncertainty or randomness correlating to a greater likelihood that the generative artificial intelligence model is hallucinating. In hallucination detection, thus, consistency in responses generated for the same input prompt may be used as an indication of whether the generative artificial intelligence model is hallucinating. If the responses generated by the generative artificial intelligence model are consistent (e.g., semantically consistent, even if the actual words differ), then it may be assumed that the generative artificial intelligence model is not hallucinating. As the responses generated by the generative artificial intelligence model become more inconsistent, it may be assumed that the generative artificial intelligence model is hallucinating. These techniques generally rely on the generation of multiple candidate responses using the generative artificial intelligence model. However, because internal intermediate data representations associated with a response generated by the generative artificial intelligence model generally capture abstract and high-level representations of a given textual input, coherence (or consistency) of these intermediate data representations can be used to determine whether the generative artificial intelligence model is hallucinating.

Certain aspects of the present disclosure provide techniques and apparatus for generating outputs of a generative artificial intelligence model based on hallucination detection and noise injection into intermediate layers of the generative artificial intelligence model. Generally, noise injected into the intermediate layers of the generative artificial intelligence model may be random perturbations of data introduced into hidden variables in intermediate layers of a generative artificial intelligence model. A probability distribution generated by the generative artificial intelligence model based on an input prompt and the injected noise may be used to determine a likelihood that the response is a hallucinatory output of the generative artificial intelligence model, with higher entropy (e.g., larger numbers of tokens having similar probability values in a probability distribution) being an indicator that the response is more likely to be a hallucinatory output and lower entropy being an indicator that the response is less likely to be a hallucinatory output of the generative artificial intelligence model. By doing so, certain aspects of the present disclosure may allow for accurate generation of textual responses to input queries and may minimize, or at least reduce, the likelihood that a generative artificial intelligence model outputs a response to an input query that includes factually incorrect or fabricated information.

### Example Response Generation Using Generative Artificial Intelligence Models and Injected Noise-Based Hallucination Detection

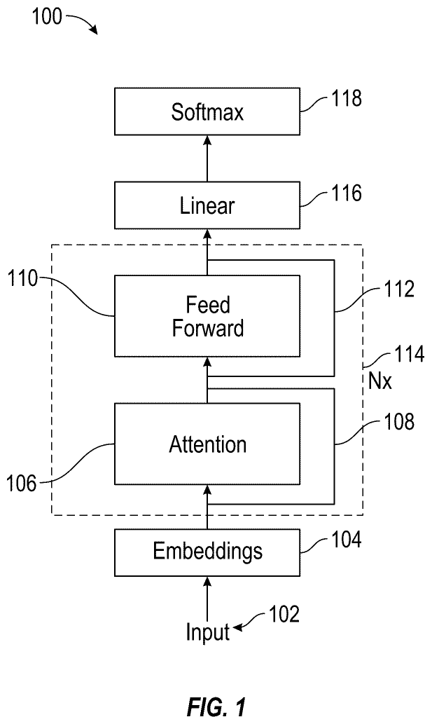

FIG. 1 depicts an example of a generative artificial intelligence model 100 trained to generate a textual response to an input prompt. The generative artificial intelligence model 100 may be implemented as a transformer-based generative artificial intelligence model, for example, as shown in FIG. 1. The generative artificial intelligence model 100 may include an embeddings block 104, an attention block 106, a feed-forward block 110, a linear block 116, and an activation block 118.

Generally, to generate a response to an input prompt, the generative artificial intelligence model 100 receives an input prompt 102. Generally, the input prompt 102 may correspond to initial data provided to the model as an input, which may include text, images, or other structured information. The input prompt 102 may, in some aspects, be preprocessed for compatibility with the model. In the case of text, preprocessing might involve tokenization, which breaks down sentences or phrases into individual units (tokens) such as words or parts of words.

The tokenized input data may subsequently be input into the embeddings block 104 to generate embedding representations of the tokenized input data. The embedding representations of the tokenized input data generally are mathematical representations of the tokens that allow for mathematical operations to be performed on the tokens. Generally, the embeddings may be vectors that capture semantic information about the tokens, allowing the model to understand relationships between words or phrases in a multidimensional space. Embeddings help reduce the complexity of the input data by encoding the data's meaning in a form that is more easily processed by the model. Embeddings also facilitate handling synonyms and polysemes, as similar tokens are generally located proximate to each other in the vector space (e.g., have a small distance between each other in the vector space).

The attention block 106 includes attention mechanisms that allow the generative artificial intelligence model 100 to focus on specific parts of the input data while processing a given token. Generally, selective attention allows the generative artificial intelligence model 100 to weigh the relevance of different tokens based on the tokens' contextual importance. Attention mechanisms allow the generative artificial intelligence model 100 to retain context over long sequences of input data, making it possible to generate coherent and contextually appropriate outputs even when handling complex or lengthy texts. Attention generally also allows for responses to be generated based on understanding dependencies between distant parts of the input. The operations in the attention block 106 may be performed in a loop 108 to capture semantic information within a large input, such as a lengthy input prompt, an input prompt and one or more tokens generated in response to the input prompt, or the like.

After the tokenized version of the input has been processed through the attention block 106, an attention output, which may be attention-weighted vectors generated based on a weight matrix and the vector representations of the tokens input into the attention block 106, may be input into the feed-forward block 110 for further processing. Generally, the feed-forward block 110 may include multiple layers of fully connected artificial neurons followed by a non-linear activation function. The feed-forward block 110 transforms the attention-weighted vectors into new representations that incorporate learned relationships between tokens.

While FIG. 1 illustrates a generative artificial intelligence model 100 with a single layer 114 including the attention block 106 and the feed-forward block 110, it should be recognized that the generative artificial intelligence model 100 may include any number Nx of layers 114. The various layers may be correlated to different aspects of inference, with each layer receiving an input from a preceding layer or stage.

The linear block 116 (also referred to as a prediction layer) applies a linear transformation to the output of the feed-forward block 110 (e.g., in the last layer 114) to reduce the dimensionality of the output data, preparing the output for the final classification or output generation. The linear block 116 may map the high-dimensional vector space back into a lower-dimensional space, where each dimension corresponds to a specific token or output feature. The linear transformation performed by the linear block 116 effectively converts the model's intermediate representation of tokens into a form suitable for generating specific outputs, such as probabilities for each possible next token in text-generation tasks in the case of language models.

To generate an output of the generative artificial intelligence model 100, such as the next token representing a word or part of a word to output as at least part of a response to an input query, the output of the linear block 116 may be input into the activation block 118 (illustrated as a softmax block implementing the softmax function, though it should be recognized that any appropriate activation function can be used to generate the output of the generative artificial intelligence model 100) for processing. In the example of a softmax block, as illustrated in FIG. 1, the softmax function converts the output of the linear block 116, which may be scores or other data associated with different candidate outputs, into probabilities. The sum of the output probabilities generated by the activation block 118, if implemented as a softmax block, generally equals one. In a text-generation example using a language model, for example, the activation block 118 produces a probability distribution over all possible next tokens (i.e., next words or portions of words), allowing the model to select the most likely token to generate. The output of the activation block 118 may be used to select the next token to output (e.g., as the token with the highest probability value in the probability distribution).

As discussed, because internal representations of data in the generative artificial intelligence model 100 may capture high-level representations of an input prompt while token embeddings may capture representations that reduce these high-level representations into a syntactic form, perturbations of these high-level representations may allow for efficient assessments of whether a generative artificial intelligence model is hallucinating or not.

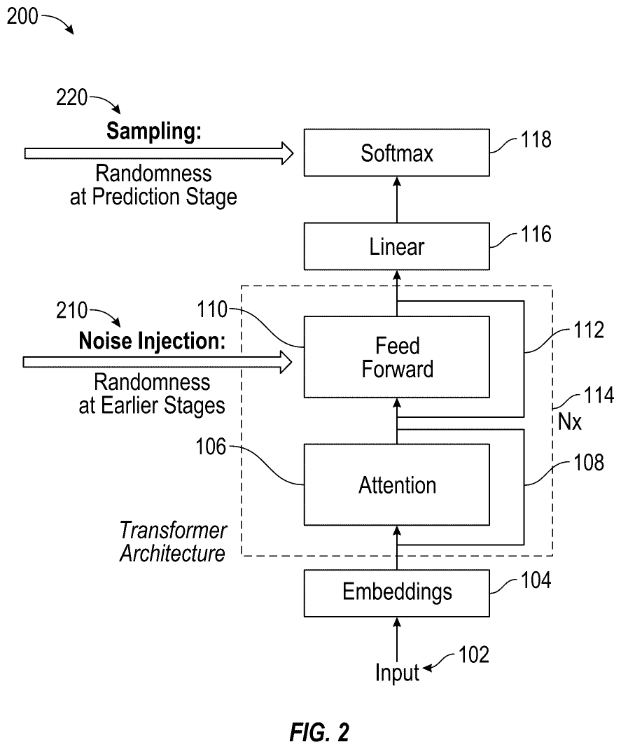

FIG. 2 illustrates an example generative artificial intelligence model 200 in which noise is introduced in one or more intermediate layers of the generative artificial intelligence model 200 to allow for hallucination detection, according to certain aspects of the present disclosure.

To determine whether a generative artificial intelligence model is hallucinating, randomness sampling may be performed based on noise injection 210 and at a sampling stage 220 on outputs of the generative artificial intelligence model 200. Generally, noise injection 210 may be performed by combining a noise source with various data points in a given layer 114; for example, noise may be added to an input into the attention block 106 of the generative artificial intelligence model 200, to an input into the feed-forward block 112 of the generative artificial intelligence model 200, or the like. The noise may be uniform noise (e.g., white noise), Gaussian noise, multiplicative noise, or another type of noise that allows for random perturbations to be introduced into data in one or more layers 114 of the generative artificial intelligence model 200. Mathematically, the output of a perturbed layer in which noise injection 210 is performed may be represented as

$${\tilde{h}}_{t}^{l} = {h}_{t}^{l} + ϵ ,$$

where ∈ represents a noise sampled from a noise input, l represents the l^{th} layer 114 of the generative artificial intelligence model 200, and t corresponds to the t^{th} input token into the generative artificial intelligence model. The token predicted to be generated by the generative artificial intelligence model 200 may be represented as a conditional probability of a token being selected as an output of the generative artificial intelligence model, which may be represented as a function of a plurality of non-perturbed layers

$${h}_{t}^{l}$$

and one or more perturbed layers

$${\tilde{h}}_{t}^{l} .$$

In some aspects, the data that is perturbed by the introduction of noise into a layer 114 of the generative artificial intelligence model 200 may be selected randomly or based on an a-priori-defined pattern that allows for an assessment of how different portions of the layer 114 contribute to whether the generative artificial intelligence model 200 is likely to generate a hallucinatory response to an input prompt. The noise added to data in a layer 114 of the generative artificial intelligence model may be, for example, determined randomly, based on a probability distribution, or selected according to a predetermined pattern. In some aspects, the amount of change in any one data value may be selected based on a random selection from a normal distribution. In some aspects, the amount by which a data sample within the layer 114 is changed (e.g., by the injection of noise into the layer 114) may be controlled based on techniques that test the hallucination propensity of the generative artificial intelligence model 200 as a function of the amount of noise injected in any one or more artificial neurons at the intermediate layer or stage. Further, the amount of change may be additive (i.e., changing a value by addition or subtraction) or multiplicative (e.g., changing a value by multiplying the value by a positive value).

While FIG. 2 illustrates noise injection 210 into one layer of the generative artificial intelligence model 200, it should be recognized that the generative artificial intelligence model 200 may include any number of layers 114, and noise injection 210 may be performed on any number of layers within the generative artificial intelligence model 200. In some aspects, injecting noise into different layers 114 in the generative artificial intelligence model 200 may allow for an assessment of which layers contribute to the generation of hallucinatory outputs by the generative artificial intelligence model, for example, when the same input prompt is processed repeatedly by the generative artificial intelligence model 200.

At the sampling stage 220, one or more responses may be generated to the input prompt 102 into the generative artificial intelligence model 200. Response entropy may be calculated based on the probability distributions associated with each of the responses generated by the generative artificial intelligence model 200. Generally, when the generative artificial intelligence model 200 is likely to not be generating a hallucinatory output to the input prompt 102, response entropy may be lower than when the generative artificial intelligence model 200 is likely to have generated a hallucinatory output to the input prompt 102. To calculate response entropy, the probability of each unique response being an output of the generative artificial intelligence model 200 may be calculated over the number of responses generated by the generative artificial intelligence model 200. For example, response entropy may be represented by the equation:

$${E}_{response} ( y ) = - {\sum }_{j} p ( {a}_{j} ) log p ( {a}_{j} )$$

where p(aⱼ) represents the probability of a unique response aⱼ over the K responses extracted from the outputs y={y¹, y², . . . y^{K}}.

The calculated entropy for the responses generated by the generative artificial intelligence model 200 may be compared to a threshold entropy value to determine whether the generative artificial intelligence model 200 is likely to have generated a hallucinatory output in response to the input prompt 102. If the calculated entropy for the responses generated by the generative artificial intelligence model 200 is less than the threshold entropy value, a response generated by the generative artificial intelligence model may be output as a response to the input prompt. For example, the response selected for output as the response to the input prompt may be the response that most frequently was generated by the generative artificial intelligence model 200 in response to the input prompt 102. If, however, the calculated entropy for the responses generated by the generative artificial intelligence model 200 exceeds the threshold entropy value, no response may be output, an indication may be output along with a candidate response indicating that the candidate response may not be an accurate response, or the like.

While the hallucination detection and noise injection illustrated in FIG. 2 is illustrated with respect to a transformer-based generative artificial intelligence model that generates textual responses to textual inputs, it should be recognized that the techniques discussed herein may be applicable to a variety of generative artificial intelligence models that generate outputs in response to an input.

### Example Operations for Response Generation Using Generative Artificial Intelligence Models and Injected Noise-Based Hallucination Detection

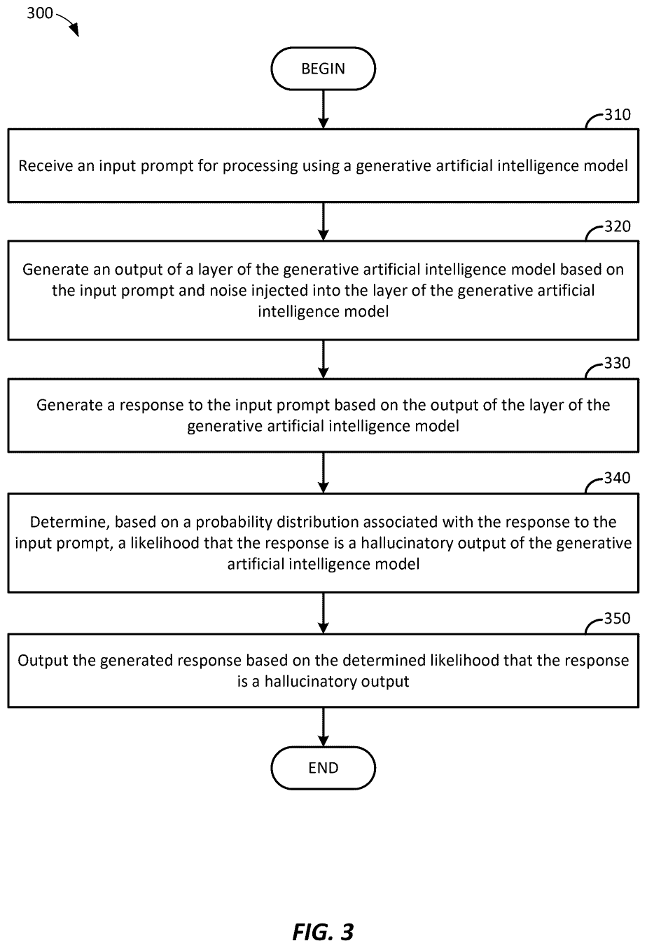

FIG. 3 illustrates example operations 300 for generating an output of a generative artificial intelligence model (e.g., the generative artificial intelligence model 200 illustrated in FIG. 2) based on a likelihood that the generative artificial intelligence model is hallucinating, according to certain aspects of the present disclosure. The operations 300 may be performed, for example, by a computing device on which a generative artificial intelligence model is deployed to generate responses to an input prompt, such as a smartphone, a tablet computer, a laptop, a desktop computer, a server, a cloud computing instance that exposes a generative artificial intelligence model to a variety of users, or the like.

As illustrated, the operations 300 begin at block 310, with receiving an input prompt for processing using a generative artificial intelligence model.

At block 320, the operations 300 proceed with generating an output of a layer of the generative artificial intelligence model based on the input prompt and noise injected into the layer of the generative artificial intelligence model.

In some aspects, the layer of the generative artificial intelligence model comprises a transformer layer. In this case, the noise may be injected into an attention block of the transformer layer.

In some aspects, the noise is injected into a feedforward block of the layer.

Generally, as discussed above, noise may be injected into any number of layers of the generative artificial intelligence model to perturb inputs processed by the layers of the generative artificial intelligence model. In some aspects, earlier layers of the generative artificial layer may be unperturbed, and noise may be injected into later layers of the generative artificial intelligence model.

At block 330, the operations 300 proceed with generating a response to the input prompt based on the output of the layer of the generative artificial intelligence model.

At block 340, the operations 300 proceed with determining, based on a probability distribution associated with the response to the input prompt, a likelihood that the response is a hallucinatory output of the generative artificial intelligence model.

At block 350, the operations 300 proceed with outputting the generated response based on the determined likelihood that the response is a hallucinatory output.

In some aspects, the response comprises an output of a current inferencing round and outputs of one or more prior inferencing rounds of the generative artificial intelligence model.

In some aspects, the operations 300 further include receiving a second input prompt for processing using the generative artificial intelligence model. A second output of the layer of the generative artificial intelligence model is generated based on the second input prompt and other noise injected into the layer of the generative artificial intelligence model. A response to the second input prompt is generated based on the second output of the layer of the generative artificial intelligence model. Based on a second probability distribution associated with the response to the input prompt and the response to the second input prompt, a second likelihood that one or more of the response to the input prompt or the response to the second input prompt is a hallucinatory output of the generative artificial intelligence model is determined. One or more actions are taken with respect to at least one of the response to the input prompt or the response to the second input prompt based on the determined second likelihood that one or more of the response to the input prompt or the response to the second input prompt is a hallucinatory output. For example, based on the determined likelihood indicating that the response to the input prompt or the response to the second input prompt is not a hallucinatory output, one or both of the response to the input prompt or the response to the second input prompt may be output. In another example, based on the determined likelihood indicating that the response to the input prompt or the response to the second input prompt is a hallucinatory output of the generative artificial intelligence model, one or both of the response to the input prompt or the response to the second input prompt may be discarded (e.g., removed from a previously displayed or output response to a user of the generative artificial intelligence model, discarded and not output to the user of the generative artificial intelligence model, etc.).

In some aspects, generating the output of the layer of the generative artificial intelligence model comprises adding noise to an intermediate output of the layer of the generative artificial intelligence model. The noise may be, for example, sampled from a uniform noise distribution, a Gaussian noise distribution, a multiplicative noise source, or the like.

In some aspects, the generative artificial intelligence model comprises a neural network including one or more transformer layers and a prediction layer, and wherein the layer of the generative artificial intelligence model comprises a layer from the one or more transformer layers.

In some aspects, determining the likelihood that the response is a hallucinatory output of the generative artificial intelligence model comprises determining whether an entropy associated with candidate responses to the input prompt exceeds a threshold entropy. If, for example, the determined entropy is less than the threshold entropy, the generated response may be output. If, however, the determined entropy is greater than the threshold entropy, indicating that the generative artificial intelligence model has generated or is likely to have generated a hallucinatory output in response to the input prompt, the response may be discarded or may be output in conjunction with information indicating that the response may not include accurate or correct information.

### Example Processing Systems for Response Generation Using Generative Artificial Intelligence Models and Injected Noise-Based Hallucination Detection

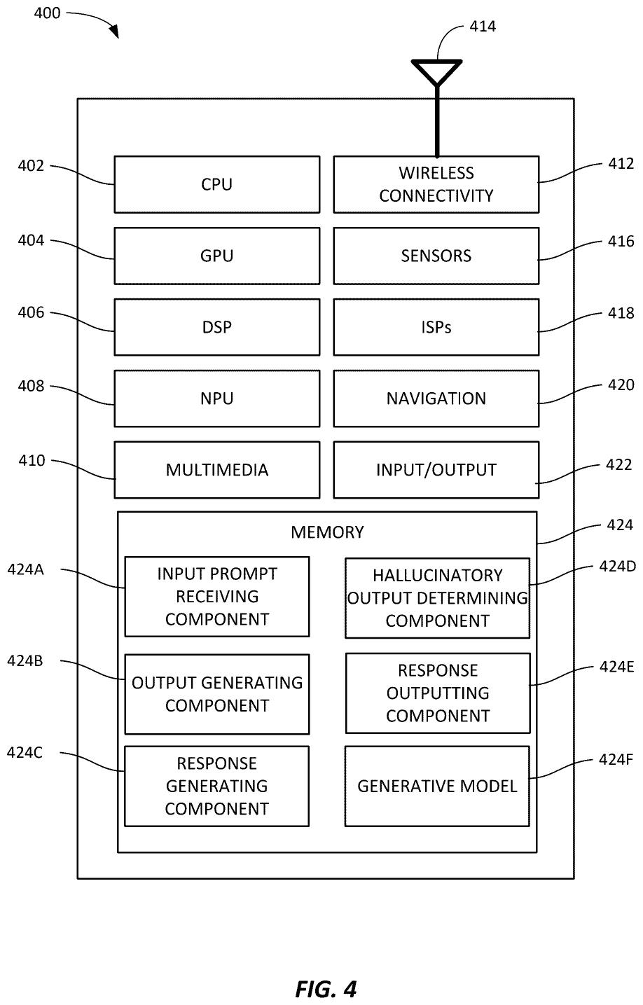

FIG. 4 depicts an example processing system 400 for using a generative artificial intelligence model to generate an output based on injected noise-based hallucination detection, such as described herein with respect to FIGS. 2-3, for example.

The processing system 400 includes a central processing unit (CPU) 402, which in some examples may be a multi-core CPU. Instructions executed at the CPU 402 may be loaded, for example, from a program memory associated with the CPU 402 or may be loaded from a memory partition (e.g., of a memory 424).

The processing system 400 also includes additional processing components tailored to specific functions, such as a graphics processing unit (GPU) 404, a digital signal processor (DSP) 406, a neural processing unit (NPU) 408, and a connectivity component 412.

An NPU, such as the NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 408, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 408 is a part of one or more of the CPU 402, the GPU 404, and/or the DSP 406. These may be located on a user equipment (UE) in a wireless communication system or another computing device.

In some examples, the connectivity component 412 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 412 may be further coupled to one or more antennas 414.

The processing system 400 may also include one or more sensor processing units 416 associated with any manner of sensor, one or more image signal processors (ISPs) 418 associated with any manner of image sensor, and/or a navigation processor 420, which may include satellite-based positioning system components (e.g., GPS or GLONASS) as well as inertial positioning system components.

The processing system 400 may also include one or more input and/or output devices 422, such as screens, touch-sensitive surfaces (including touch-sensitive displays), physical buttons, speakers, microphones, and the like.

In some examples, one or more of the processors of the processing system 400 may be based on an ARM or RISC-V instruction set.

The processing system 400 also includes the memory 424, which is representative of one or more static and/or dynamic memories, such as a dynamic random access memory, a flash-based static memory, and the like. In this example, the memory 424 includes computer-executable components, which may be executed by one or more of the aforementioned processors of the processing system 400.

In particular, in this example, the memory 424 includes an input prompt receiving component 424A, an output generating component 424B, a response generating component 424C, a hallucinatory output determining component 424D, a response outputting component 424E, and a generative model 424F. The depicted components, and others not depicted, may be configured to perform various aspects of the methods described herein.

Generally, the processing system 400 and/or components thereof may be configured to perform the methods described herein.

### Example Clauses

Implementation details of various aspects of the present disclosure are described in the following numbered clauses.

Clause 1: A processor-implemented method for machine learning, comprising: receiving an input prompt for processing using a generative artificial intelligence model; generating an output of a layer of the generative artificial intelligence model based on the input prompt and noise injected into the layer of the generative artificial intelligence model; generating a response to the input prompt based on the output of the layer of the generative artificial intelligence model; determining, based on a probability distribution associated with the response to the input prompt, a likelihood that the response is a hallucinatory output of the generative artificial intelligence model; and outputting the generated response based on the determined likelihood that the response is a hallucinatory output.

Clause 2: The method of Clause 1, wherein the response comprises an output of a current inferencing round and outputs of one or more prior inferencing rounds of the generative artificial intelligence model.

Clause 3: The method of Clause 1 or 2, further comprising: receiving a second input prompt for processing using the generative artificial intelligence model; generating a second output of the layer of the generative artificial intelligence model based on the second input prompt and other noise injected into the layer of the generative artificial intelligence model; generating a response to the second input prompt based on the second output of the layer of the generative artificial intelligence model; determining, based on a second probability distribution associated with the response to the input prompt and the response to the second input prompt, a second likelihood that one or more of the response to the input prompt or the response to the second input prompt is a hallucinatory output of the generative artificial intelligence model; and taking one or more actions with respect to at least one of the response to the input prompt or the response to the second input prompt based on the determined second likelihood that one or more of the response to the input prompt or the response to the second input prompt is a hallucinatory output.

Clause 4: The method of any of Clauses 1 through 3, wherein the layer of the generative artificial intelligence model comprises a transformer layer, and wherein the noise is injected into an attention block of the transformer layer.

Clause 5: The method of any of Clauses 1 through 4, wherein the noise is injected into a feedforward block of the layer.

Clause 6: The method of any of Clauses 1 through 5, wherein generating the output of the layer of the generative artificial intelligence model comprises adding noise to an intermediate output of the layer of the generative artificial intelligence model.

Clause 7: The method of any of Clauses 1 through 6, wherein the generative artificial intelligence model comprises a neural network including one or more transformer layers and a prediction layer, and wherein the layer of the generative artificial intelligence model comprises a layer from the one or more transformer layers.

Clause 8: The method of any of Clauses 1 through 7, wherein determining the likelihood that the response is a hallucinatory output of the generative artificial intelligence model comprises determining whether an entropy associated with candidate responses to the input prompt exceeds a threshold entropy.

Clause 9: The method of Clause 8, wherein the generated response is output based on the determined entropy being less than the threshold entropy.

Clause 10: A processing system, comprising: at least one memory having executable instructions stored thereon; and one or more processors configured to execute the executable instructions in order to cause the processing system to perform the operations of any of Clauses 1 through 9.

Clause 11: A processing system, comprising: means for performing the operations of any of Clauses 1 through 9.

Clause 12: A non-transitory computer-readable medium having executable instructions stored thereon which, when executed by one or more processors, perform the operations of any of Clauses 1 through 9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
one or more memories comprising processor-executable instructions; and
one or more processors coupled to the one or more memories and configured to execute the processor-executable instructions and cause the processing system to:
receive an input prompt for processing using a generative artificial intelligence model;
generate an output of a layer of the generative artificial intelligence model based on the input prompt and noise injected into the layer of the generative artificial intelligence model;
generate a response to the input prompt based on the output of the layer of the generative artificial intelligence model;
determine, based on a probability distribution associated with the response to the input prompt, a likelihood that the response is a hallucinatory output of the generative artificial intelligence model; and
output the generated response based on the determined likelihood that the response is a hallucinatory output.

2. The processing system of claim 1, wherein the response comprises an output of a current inferencing round and outputs of one or more prior inferencing rounds of the generative artificial intelligence model.

3. The processing system of claim 1, wherein the one or more processors are configured to execute the processor-executable instructions and further cause the processing system to:
receive a second input prompt for processing using the generative artificial intelligence model;
generate a second output of the layer of the generative artificial intelligence model based on the second input prompt and other noise injected into the layer of the generative artificial intelligence model;
generate a response to the second input prompt based on the second output of the layer of the generative artificial intelligence model;
determine, based on a second probability distribution associated with the response to the input prompt and the response to the second input prompt, a second likelihood that one or more of the response to the input prompt or the response to the second input prompt is a hallucinatory output of the generative artificial intelligence model; and
take one or more actions with respect to at least one of the response to the input prompt or the response to the second input prompt based on the determined second likelihood that one or more of the response to the input prompt or the response to the second input prompt is a hallucinatory output.

4. The processing system of claim 1, wherein the layer of the generative artificial intelligence model comprises a transformer layer and wherein the noise is injected into an attention block of the transformer layer.

5. The processing system of claim 1, wherein the noise is injected into a feedforward block of the layer.

6. The processing system of claim 1, wherein to generate the output of the layer of the generative artificial intelligence model, the one or more processors are configured to execute the processor-executable instructions and cause the processing system to add noise to an intermediate output of the layer of the generative artificial intelligence model.

7. The processing system of claim 1, wherein the generative artificial intelligence model comprises a neural network including one or more transformer layers and a prediction layer and wherein the layer of the generative artificial intelligence model comprises a layer from the one or more transformer layers.

8. The processing system of claim 1, wherein to determine the likelihood that the response is a hallucinatory output of the generative artificial intelligence model, the one or more processors are configured to execute the processor-executable instructions and cause the processing system to determine whether an entropy associated with candidate responses to the input prompt exceeds a threshold entropy.

9. The processing system of claim 8, wherein the one or more processors are configured to execute the processor-executable instructions and cause the processing system to output the generated response based on the determined entropy being less than the threshold entropy.

10. A processor-implemented method for machine learning, comprising:
receiving an input prompt for processing using a generative artificial intelligence model;
generating an output of a layer of the generative artificial intelligence model based on the input prompt and noise injected into the layer of the generative artificial intelligence model;
generating a response to the input prompt based on the output of the layer of the generative artificial intelligence model;
determining, based on a probability distribution associated with the response to the input prompt, a likelihood that the response is a hallucinatory output of the generative artificial intelligence model; and
outputting the generated response based on the determined likelihood that the response is a hallucinatory output.

11. The method of claim 10, wherein the response comprises an output of a current inferencing round and outputs of one or more prior inferencing rounds of the generative artificial intelligence model.

12. The method of claim 10, further comprising:
receiving a second input prompt for processing using the generative artificial intelligence model;
generating a second output of the layer of the generative artificial intelligence model based on the second input prompt and other noise injected into the layer of the generative artificial intelligence model;
generating a response to the second input prompt based on the second output of the layer of the generative artificial intelligence model;
determining, based on a second probability distribution associated with the response to the input prompt and the response to the second input prompt, a second likelihood that one or more of the response to the input prompt or the response to the second input prompt is a hallucinatory output of the generative artificial intelligence model; and
taking one or more actions with respect to at least one of the response to the input prompt or the response to the second input prompt based on the determined second likelihood that one or more of the response to the input prompt or the response to the second input prompt is a hallucinatory output.

13. The method of claim 10, wherein the layer of the generative artificial intelligence model comprises a transformer layer and wherein the noise is injected into an attention block of the transformer layer.

14. The method of claim 10, wherein the noise is injected into a feedforward block of the layer.

15. The method of claim 10, wherein generating the output of the layer of the generative artificial intelligence model comprises adding noise to an intermediate output of the layer of the generative artificial intelligence model.

16. The method of claim 10, wherein the generative artificial intelligence model comprises a neural network including one or more transformer layers and a prediction layer and wherein the layer of the generative artificial intelligence model comprises a layer from the one or more transformer layers.

17. The method of claim 10, wherein determining the likelihood that the response is a hallucinatory output of the generative artificial intelligence model comprises determining whether an entropy associated with candidate responses to the input prompt exceeds a threshold entropy.

18. The method of claim 17, wherein the generated response is output based on the determined entropy being less than the threshold entropy.

19. A processing system comprising:
means for receiving an input prompt for processing using a generative artificial intelligence model;
means for generating an output of a layer of the generative artificial intelligence model based on the input prompt and noise injected into the layer of the generative artificial intelligence model;
means for generating a response to the input prompt based on the output of the layer of the generative artificial intelligence model;
means for determining, based on a probability distribution associated with the response to the input prompt, a likelihood that the response is a hallucinatory output of the generative artificial intelligence model; and
means for outputting the generated response based on the determined likelihood that the response is a hallucinatory output.

20. The processing system of claim 19, further comprising:
means for receiving a second input prompt for processing using the generative artificial intelligence model;
means for generating a second output of the layer of the generative artificial intelligence model based on the second input prompt and other noise injected into the layer of the generative artificial intelligence model;
means for generating a response to the second input prompt based on the second output of the layer of the generative artificial intelligence model;
means for determining, based on a second probability distribution associated with the response to the input prompt and the response to the second input prompt, a second likelihood that one or more of the response to the input prompt or the response to the second input prompt is a hallucinatory output of the generative artificial intelligence model; and
means for taking one or more actions with respect to at least one of the response to the input prompt or the response to the second input prompt based on the determined second likelihood that one or more of the response to the input prompt or the response to the second input prompt is a hallucinatory output.
